(19) United States
(12) Patent Application Publication
(10) Pub. No.: US 2015/0152928 A1
(43) Pub. Date: Jun. 4, 2015

(54) ELECTRONIC PARKING BRAKE

(71) Applicant: MANDO CORPORATION, Pyeongtaek-si (KR)

(72) Inventor: Jae-Seop YOON, Yongin-si (KR)

(21) Appl. No.: 14/308,042

(22) Filed: Jun. 18, 2014

(30) Foreign Application Priority Data
Nov. 29, 2013 (KR) 10-2013-0147090

(51) Int. Cl. F16D 65/14; F16D 51/00

(52) U.S. Cl. CPC F16D 65/14; F16D 51/00

(57) ABSTRACT

A electronic parking brake which includes a drum rotated together with a wheel of a vehicle, first and second brake shoes installed in both inner sides of the drum to brake the drum, and an operation lever configured to support the two brake shoes and to push the two brake shoes toward an inner surface of the drum when a rotational lever is pulled, includes an actuator configured to generate a driving power driving the rotational lever, wherein the actuator includes a motor configured to be rotated forwardly and reversely and to generate a driving power for braking, a decelerator configured to amplify the driving power generated from the motor, and a power conversion unit configured to receive a rotational force from the decelerator and convert the rotational force into a linear motion.

### CROSS-REFERENCE TO RELATED APPLICATION

This application claims the benefit of Korean Patent Application No. P2013-0147090, filed on Nov. 29, 2013 in the Korean Intellectual Property Office, the disclosure of which is incorporated herein by reference.

### BACKGROUND

1. Field

Embodiments of the present invention relate to a brake installed at a vehicle, and more particularly, to an electronic parking brake which is operated by a motor.

2. Description of the Related Art

Generally, a parking brake is an apparatus for stopping a vehicle not to be moved when the vehicle is parked, and serves to prevent a wheel of the vehicle from being rotated. The parking brake is formed in a drum-in-hat (DIH) type brake system. Typically, in the parking brake, a parking cable is pulled according to an operation of a hand brake or a foot brake, and thus a braking force is generated. At this time, when a drum brake is used for the parking brake, the DIH type brake is used in a state of being coupled with a disc brake for braking a rear wheel, instead of a hydraulic brake.

FIG. 1 is a cross-sectional view illustrating a partial configuration of a vehicle having a conventional manual parking brake.

Referring to the drawing, the parking brake includes a drum 1 which is rotated with a wheel (not shown) of the vehicle, and a first brake shoe 2 and a second brake shoe 3 installed in the drum 1 to brake the drum 1 through friction with an inner surface of the drum 1. Also, an operation lever 5 configured to push the two brake shoes 2 and 3 to the inner surface of the drum 1 when a parking cable 4 connected with a parking lever (not shown) located around a driver's seat is pulled is provided in the drum 1.

The operation lever 5 includes a support lever 6 of which one end is supported by a web 2a of the first brake shoe 2 and the other end extends toward the second brake shoe 3, and a rotational lever 7 rotatably coupled to the end of the support lever 6, which extends toward the second brake shoe 3, and configured to support a web 3a of the second brake shoe 3.

The rotational lever 7 includes a support portion 7a provided at a position spaced apart in a predetermined distance from a rotational shaft 8 coupled with the support lever 6 and configured to support the web 3a of the second brake shoe 3, and a loop portion 7b provided at an end thereof extending from the rotational shaft 8 toward the first brake shoe 2 in a predetermined length so that an end of the parking cable 4 is caught and coupled thereto. The parking cable 4 configured to operating the rotational lever 7 has a hook portion 4a provided at an end thereof, such that the hook portion 4a passes through a back plate 9 coupled to a knuckle portion (not shown) of the vehicle, enters an inner side of the drum 1, and then is coupled to the loop portion 7b of the rotational lever 7.

When the parking cable 4 connected with the parking lever (not shown) located around the driver's seat is pulled, the rotational lever 7 is rotated around the rotational shaft 8, and the support portion 7a of the rotational lever 7 spaced apart from the rotational shaft 8 pushes the web 3a of the second brake shoe 3 toward the inner surface of the drum 1, and the support lever 6 is moved forward toward the first brake shoe 2 by a reaction force applied to the support lever 6, and pushes the web 2a of the first brake shoe 2 so that the two brake shoes 2 and 3 are in close contact with the inner surface of the drum 1. That is, braking of the vehicle is achieved by such operation.

However, in the manual parking brake, it is inconvenient for the user to pull the parking lever with a proper force, and particularly, in case of women, and the old and the weak, it is difficult to generate a sufficient braking force. Further, since the parking lever has a large operation radius, the indoor space occupancy of the vehicle is lowered.

To overcome the various disadvantages in the manual parking brake, there has been an electronic parking brake which automatically operates a brake using a motor. However, there is another problem in that the electronic parking brake may not be used in the vehicle having the manual parking brake.

### SUMMARY

Therefore, it is an aspect of the present invention to provide an electronic parking brake which generates a braking force through a rotational force generated from a motor, improves connection structures among construction components, and thus more smoothly and stably operated.

It is another aspect of the present invention to provide an electronic parking brake which may electronically perform a parking function by installing an actuator at an existing DIH type brake.

Additional aspects of the invention will be set forth in part in the description which follows and, in part, will be obvious from the description, or may be learned by practice of the invention.

In accordance with one aspect of the present invention, an electronic parking brake which includes a drum rotated together with a wheel of a vehicle, first and second brake shoes installed in both inner sides of the drum to brake the drum, and an operation lever configured to support the two brake shoes and to push the two brake shoes toward an inner surface of the drum when a rotational lever is pulled, includes an actuator configured to generate a driving power driving the rotational lever, wherein the actuator includes a motor configured to be rotated forwardly and reversely and to generate a driving power for braking, a decelerator configured to amplify the driving power generated from the motor, and a power conversion unit configured to receive a rotational force form the decelerator and convert the rotational force into a linear motion, and the power conversion unit is connected to a parking cable connected with the rotational lever to operate the parking cable.

The decelerator may include a worm gear formed at a rotational shaft of the motor, and a worm wheel shaft having a worm wheel engaged with the worm gear and disposed to be intersected with the rotational shaft.

The power conversion unit may include a pinion gear installed at the worm wheel shaft to be rotated together with the worm wheel, and a rack gear engaged with the pinion gear and configured to be linearly moved according to rotation of the pinion gear, and the parking cable may be connected to an end of the rack gear.

A support portion may be formed at the worm wheel shaft to protrude radially between the worm wheel and the pinion gear.

A braking force may be changed by selectively changing a diameter of the pinion gear, when a braking operation is performed.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view schematically illustrating configuration of a conventional parking brake;

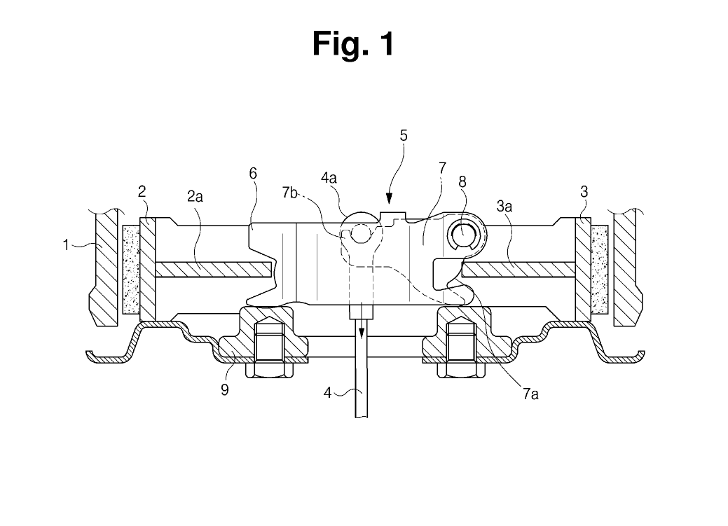

FIG. 2 is a cross-sectional view schematically illustrating configuration of an electronic partaking brake according to one embodiment of the present invention;

FIG. 3 is a perspective view extracting and illustrating an actuator provided at the electronic partaking brake according to one embodiment of the present invention; and

FIG. 4 is a cross-sectional view illustrating a braking state of the electronic partaking brake according to one embodiment of the present invention.

[Detailed Description of Main Elements]

| | |
|---|---|
| 10: electronic parking brake | 100: actuator |
| 110: motor | 111: rotational shaft |
| 120: decelerator | 121: worm gear |
| 122: worm wheel | 123: worm wheel shaft |
| 130: power conversion unit | 133: pinion gear |
| 134: rack gear | 140: housing |

### DETAILED DESCRIPTION

Hereinafter, the embodiments of the present invention will be described in detail with reference to accompanying drawings. It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

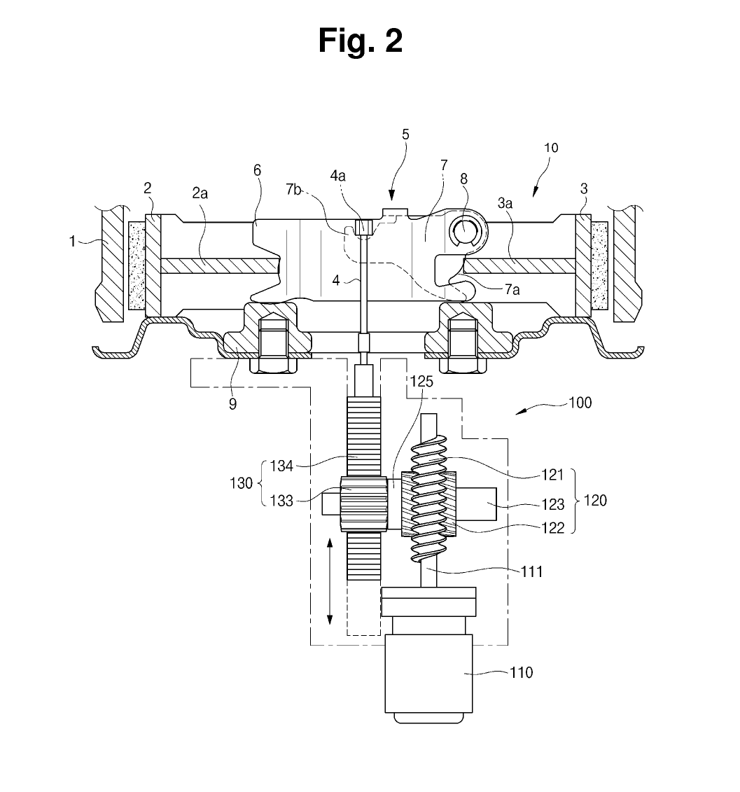

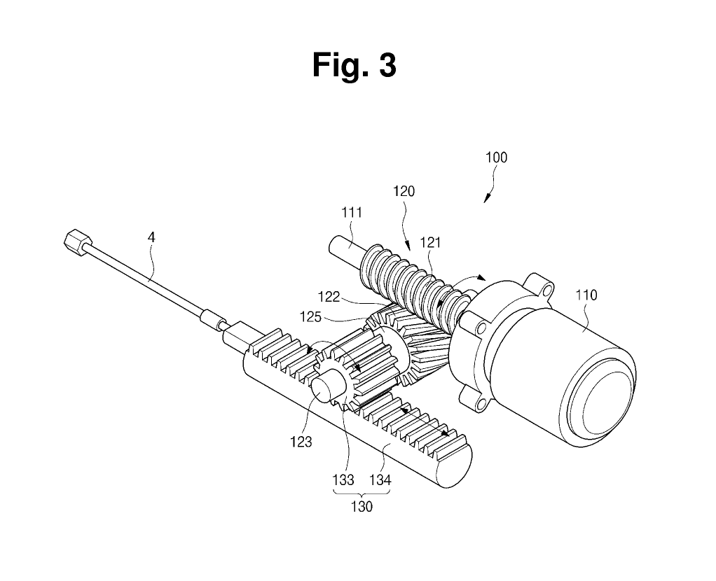

FIG. 2 is a cross-sectional view schematically illustrating configuration of an electronic partaking brake according to one embodiment of the present invention, and FIG. 3 is a perspective view extracting and illustrating an actuator provided at the electronic partaking brake according to one embodiment of the present invention. Here, the same reference numeral as that in the drawing illustrating the conventional parking brake has the same function.

Referring to FIGS. 2 and 3, the electronic parking brake 10 include a drum 1 rotated together with a wheel (not shown) of a vehicle, first and second brake shoes 2 and 3 installed in the drum 1 to brake the drum 1 through friction with an inner surface of the drum 1, an operation lever 5 configured to push the two brake shoes 2 and 3 toward the inner surface of the drum 1 when a rotational lever 7 is pulled, and an actuator 100 electronically operated to generate a driving power.

Further, the actuator 100 includes a motor 110 configured to generate a driving power for driving the rotational lever 7, a decelerator 120 connected with the motor 110, a power conversion unit 130 configured to receive the driving power amplified by the decelerator 120 and to covert a rotary motion into a linear motion, and a housing 140 in which the decelerator 120 and the power conversion unit 130 are accommodated and which is fixed to a knuckle portion (not shown).

In the electronic parking brake 10 having the above-mentioned configuration, the operation lever 5 which presses the first and second brake shoes 2 and 3 toward the inner surface of the drum 1 and generated the braking force has the same configuration and effect as those in the conventional one, and thus detailed description thereof will be omitted. At this time, as illustrated in the drawing, the rotational lever 7 has one pair of ends which are spaced apart from each other in a predetermined distance, and is coupled a support lever 6 by the rotational shaft 8 so as to be extend toward the first brake shoe 2 in a predetermined length, the one pair of the ends of the rotational lever 7 a loop portion 7b so that an end of a parking cable 4 is inserted and hooked therein.

The motor 110 generates the driving power which generates the rotational force in normal and reverse directions and drives the rotational lever 7. The motor 110 is connected with a control device (not shown) which is connected with the motor 110 to control an operation thereof. For example, the control device controls various operation of the motor 110, such as driving, stopping, normal rotating, and reverse rotating, through an input signal transmitted according to an operation command of an operation switch by a driver. When a brake operation or release command is applied by the driver, the control device rotates the motor 110 in the normal or reverse direction. Further, the control device may be configured to have a load sensor (not shown) configured to detect a magnitude of the force applied to the rotational lever 7, to receive a signal output from the load sensor, and to stop the motor 110 when the magnitude of the force applied to the rotational lever 7 is more than a predetermined value.

The decelerator 120 serves to amplify the driving power of the motor 110, and includes a worm gear 121 formed at a rotational shaft 111 of the motor 110, a worm wheel 122 engaged with the worm gear 121, and a worm wheel shaft 123 disposed to be intersected with the rotational shaft 111 and having a worm wheel 122 installed thereto.

As illustrated in the drawing, the worm gear 121 is integrally formed with the rotational shaft 111 of the motor 110. That is, a motor having an integral worm gear may be used. As the rotational shaft 111 of the motor 110 is rotated, the worm wheel 122 engaged with the worm gear 121 formed at the rotational shaft 111 receives the rotational force and is rotated together with the worm wheel shaft 123. At this time, the worm wheel shaft 123 is rotatably supported by the housing 140.

The worm wheel shaft 123 has a predetermined length, and a pinion gear 133 of the power conversion unit 130 to be described later is installed at the worm wheel shaft 123. A support portion 125 radially protruding is formed at an outer surface of the worm wheel shaft 123. The support portion 125 is formed between the worm wheel 122 and the pinion gear 133 to prevent the two gears 122 and 133 from being in contact with each other.

Meanwhile, although not shown, a portion in which the worm wheel 122 is installed and a portion in which a pinion gear 133 is installed may be separately formed and coupled to the worm wheel shaft 123.

The driving power amplified from the decelerator 120 is transmitted to the power conversion unit 130. The power conversion unit 130 serves to convert the rotational force transmitted from the decelerator 120 into the linear motion and to drive the rotational lever 7. More specifically, the power conversion unit 130 includes the pinion gear 133 installed at the worm wheel shaft 123, and a rack gear 134 engaged with the pinion gear 133 to be linearly moved according to rotation of the pinion gear 133.

The pinion gear 133 is installed at the worm wheel shaft 123, and thus rotated together with the worm wheel 122. The pinion gear 133 may selectively change a diameter thereof, and thus change a braking torque.

The rack gear 134 has a predetermined length, and an end thereof is connected with the parking cable 4 connected the rotational lever 7. A lengthwise direction of the rack gear 134 is disposed to be linear with a lengthwise direction of the parking cable 4 introduced into the drum 1 through a back-plate 9 coupled to the knuckle portion (not shown) of the vehicle. The rack gear 134 is slidably supported at the housing 140, performs the linear motion according to a rotational direction of the pinion gear 133 and operates the parking cable 4. That is, a braking operation is performed by pulling the parking cable 4 and rotating the rotational lever 7. Therefore, it is easily to secure a stroke through a change in a length of the rack gear 134.

Then, the braking operation of the electronic parking brake as described above will be described.

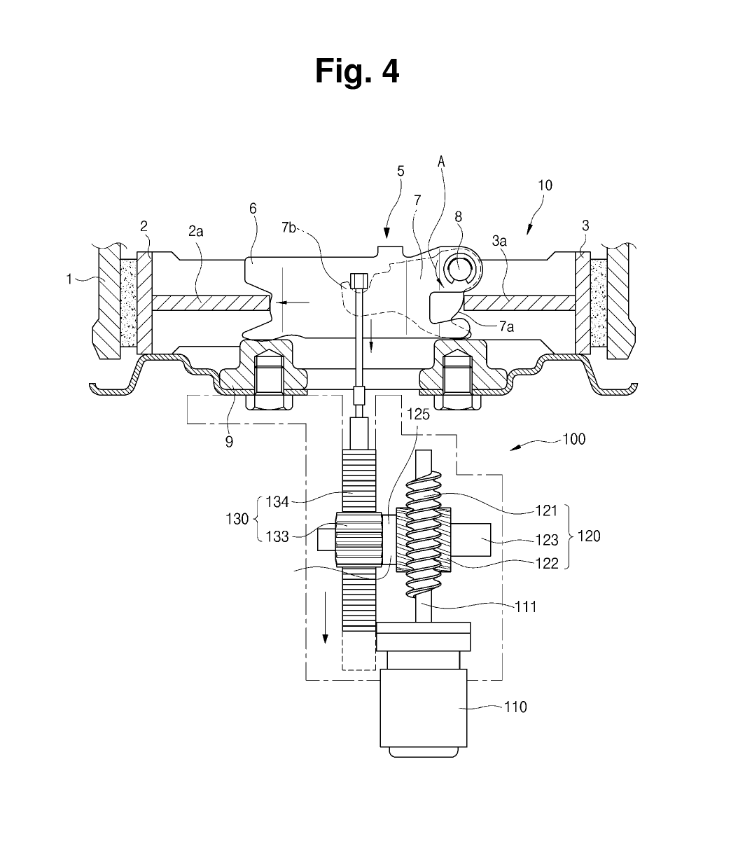

As illustrated in FIG. 2, in a state in which the two brake shoes 2 and 3 are spaced apart from the inner surface of the drum 1 (in a state in which the braking is released), when the driver of the vehicle pushes a control device (not shown), for example, an operation switch (not shown), the motor 110 generates the driving power according to a signal thereof. Thus, a deceleration is performed by the decelerator 120 which receives the rotational force of the motor 110, and the rotational force is transmitted to the power conversion unit 130 connected to the decelerator 120. Therefore, the rack gear 134 is linearly moved, and when the parking cable 4 is pulled, the rotational lever 7 connected with the parking cable 4 is pulled and rotated around the rotational shaft 8 in an arrow direction A, as illustrated in FIG. 4.

Here, due to the rotation of the rotational lever 7, the support portion 7a of the rotational lever 7 pushes the web 3a of the second brake shoe 3 toward the inner surface of the drum 1, and at the same time, the support lever 6 is moved forward toward the first brake shoe 2 by a reaction force applied to the support lever 6, and pushes the web 2c of the first brake shoe 2, and thus the two brake shoes 2 and 3 are in close contact with the inner surface of the drum 1, and the braking operation is performed.

Meanwhile, when the braking force is released, the pinion gear 133 of the power conversion unit 130 is rotated in a direction opposite to that when performing the braking operation, and thus the rack gear 134 is moved to its original position. And the parking cable 4 is released, and the two brake shoes 2 and 3 is spaced apart from the inner surface of the drum 1 by elasticity of a return spring (not shown) installed to connect each brake shoe 2, 3, and returned to its original state.

The electronic parking brake 10 as described above may be used by not changing or minimally changing components used in the conventional parking brake through the motor 110, the decelerator 120 and the power conversion unit 130. Further, since a parking lever (a hand brake or a foot brake) which is manually operated may be removed, the space occupancy may be enhanced, and also it may be used conveniently.

Since the electronic parking brake according to one embodiment of the present invention uses the motor integrally formed with the worm gear, it is possible to have a simple structure, and to selectively change the braking torque by changing the diameter of the pinion gear.

Further, it is easy to secure the stroke through the change in the length of the rack gear connected with the parking cable, and also since it can be directly installed and used at the conventional parking brake, the existing vehicle components may be used without any change.

Further, since the braking operation is performed by using the motor, it is convenient to use, and also since it is possible to reduce a space of the conventional parking lever provided around the driver's seat, the space occupancy may be enhanced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic parking brake which comprises a drum rotated together with a wheel of a vehicle, first and second brake shoes installed in both inner sides of the drum to brake the drum, and an operation lever configured to support the two brake shoes and to push the two brake shoes toward an inner surface of the drum when a rotational lever is pulled, comprising:
an actuator configured to generate a driving power driving the rotational lever,
wherein the actuator comprises a motor configured to be rotated forwardly and reversely and to generate a driving power for braking, a decelerator configured to amplify the driving power generated from the motor, and a power conversion unit configured to receive a rotational force for the decelerator and convert the rotational force into a linear motion, and the power conversion unit is connected to a parking cable connected with the rotational lever to operate the parking cable.

2. The electronic parking brake according to claim 1, wherein the decelerator comprises a worm gear formed at a rotational shaft of the motor, and a worm wheel shaft having a worm wheel engaged with the worm gear and disposed to be intersected with the rotational shaft.

3. The electronic parking brake according to claim 2, wherein the power conversion unit comprises a pinion gear installed at the worm wheel shaft to be rotated together with the worm wheel, and a rack gear engaged with the pinion gear and configured to be linearly moved according to rotation of the pinion gear, and the parking cable is connected to an end of the rack gear.

4. The electronic parking brake according to claim 3, wherein a support portion is formed at the worm wheel shaft to protrude radially between the worm wheel and the pinion gear.

5. The electronic parking brake according to claim 3, wherein a braking force is changed by selectively changing a diameter of the pinion gear, when a braking operation is performed.
